(19) United States
(12) Patent Application Publication
(10) Pub. No.: US 2006/0237201 A1
(43) Pub. Date: Oct. 26, 2006

(54) Safety device for attachment fastening device of power shovel

(75) Inventor: Takashi Moriuchi, Komatsu-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KABUSHIKI KAISHA MUROTO TEKKOSHO, Komatsu-shi (JP)

(21) Appl. No.: 11/475,089

(22) Filed: Jun. 27, 2006

(30) Foreign Application Priority Data
Jan. 7, 2005 (JP) 2005-194088

(51) Int. Cl. A01B 51/00

(52) U.S. Cl. 172/272

(57) ABSTRACT

A safety device for a device for fastening an attachment such as a bucket to the leading end of the arm of a power shovel is disclosed. Even if negligence and erroneous operation occur in combination, the attachment can be prevented from dropping from the arm end. To this end, mounting pins provided for the attachment are inserted into a pair of receiving recess portions which are arranged such that their openings face each other or their backs face each other and this inserted condition is maintained by hydraulic power. The fastening device includes: engagement metal fittings retractably attached in the vicinity of the receiving recess portions and having projections that are projectable into the openings of the recess portions; and lock members for engaging the engagement metal fittings, with their projections projecting into the openings. The safety device has sensors for detecting mounting of the lock members; and inhibiting means for inhibiting the operation of the attachment if the sensors do not detect the lock members.

### TECHNICAL FIELD

The invention relates to an attachment fastening device that is mounted on the leading end of the arm of a power shovel in order to easily, quickly attach and detach an attachment such as a bucket to and from the leading end of the arm. More particularly, the invention relates to a safety device for preventing dropping-off of the attachment due to erroneous operation or negligence.

### BACKGROUND ART

Generally, in a power shovel, an attachment such as a bucket is directly mounted on the leading end of the arm with mounting pins. However, in cases where frequent replacement of the attachment mounted on the leading end of the arm is required, an attachment fastening device is attached to the leading end of the arm and the desired attachment is mounted through the fastening device.

FIG. 3 shows, as one example of attachment fastening devices of this type, the attachment fastening device disclosed in Japanese Utility Model Kokai Publication No. 6-79849. More specifically, FIG. 3 shows one example of attachment fastening devices that include a safety device for preventing dropping-off of an attachment 14 caused by erroneous operation.

The attachment fastening device 10 shown in FIG. 3 has a pair of members 2, 3 that opens and closes, turning about a pivot pin 1 in a manner similar to that of a pair of scissors. U-shaped receiving recess portions 4, 5 are provided at the leading ends of the members 2, 3 respectively so as to open in directions opposite to each other. The members 2, 3 have pin holes 6, 7 respectively which are located at intermediate positions between the pivot pin 1 and the receiving recess portions 4, 5 respectively. The attachment fastening device 10 is mounted on the leading end of an arm 8 of a power shovel in such a manner that one pin hole 6 is pivotally connected to the leading end of the arm 8 whereas the other pin hole 7 is pivotally connected to the leading end of a front link 9.

A hydraulic cylinder 11 is provided so as to extend between the members 2, 3. This hydraulic cylinder 11 is expanded to make the receiving recess portions 4, 5 depart from each other, thereby pressing the bottom faces of the receiving recess portions 4, 5 against the inner sides of mounting pins 12, 13, respectively, of an attachment 14, so that the attachment 14 is fixed. In the neighborhood of each receiving recess 4 (5), an engagement metal fitting 18 (19) having an engagement projection 16 (17) at the leading end thereof is pivotally supported by a pin 20 (21). When each engagement metal fitting 18 (19) is turned so as to be brought into contact with the mounting pin 12,(13) inserted in the receiving recess 4 (5), the engagement projection 16 (17) projects to the opening side of the receiving recess 4 (5), thereby making the opening of the receiving recess 4 (5) smaller than the diameter of the mounting pin 12 (13). In this condition, lock pins 22, 23 are inserted into the spaces located behind the engagement metal fittings 18, 19 respectively, thereby preventing the engagement metal fittings 18, 19 from retracting. In such a condition, even if hydraulic power is imposed by erroneous operation in the direction that the cylinder 11 is contracted, the cylinder 11 will not contract and therefore dropping-off of the attachment 14 due to the erroneous operation will be prevented.

The safety device of the above-described structure has such an advantage that even if the spacing between the mounting pins 12, 13 of the attachment varies, there is no problem in mounting the attachment and preventing dropping-off of the attachment.

However, the safety device of the above structure has revealed the following problem. Suppose that the operator recklessly forgets to insert the lock pins 22, 23 after replacement of the attachment in a job site and operates the power shovel in this condition. If the cylinder 11 of the attachment fastening device is contracted by mistake during operation, the engagement metal fittings 18, 19 retract owing to the force of the cylinder 11, so that the opening parts of the receiving recess portions 4, 5 are opened, causing the mounted attachment to come off.

Specifically, the prior art safety device described earlier presents such a problem that dropping-off of the attachment from the leading end of the arm occurs, if the careless mistake of finishing an attachment mounting work without inserting the lock pins 22, 23 at the time of mounting the attachment is combined with the erroneous operation in which the operator contracts the cylinder 11 of the attachment fastening device while operating the power shovel.

### SUMMARY OF THE INVENTION

The present invention is directed to overcoming the foregoing problem and therefore provides a safety device for an attachment fastening device which has lock members similar to the above-described lock pins 22, 23, for preventing dropping-off of an attachment, the safety device being incorporated in a hydraulic circuit or electric circuit for controlling the operation of a power shovel and having an inhibiting means for inhibiting the excavation and other operations of the power shovel if the lock members are not attached to the attachment fastening device.

According to the invention, there is provided a safety device for an attachment fastening device of a power shovel, which attachment fastening device comprises: a hydraulic device (11) for increasing and decreasing the spacing between a pair of members (2, 3) having, at the leading ends thereof, receiving recess portions (4, 5) which are arranged such that their openings face each other or their backs face each other; engagement metal fittings (18, 19) mounted in the neighborhood of the receiving recess portions (4, 5) respectively so as to be freely retractable and having projections (16, 17) that are projectable into the openings of the receiving recess portions (4, 5) respectively, while two mounting pins (12, 13) provided in an attachment (14) are being inserted into the pair of receiving recess portions (4, 5) and being kept in this inserted condition with the aid of the hydraulic power of the hydraulic device (11); and lock members (22, 23) for latching the engagement metal fittings (18, 19) while the projections (16, 17) projecting into the openings,

the safety device comprising:

sensors (25, 26) for detecting mounting of the lock members (22, 23); and

inhibiting means (40) for inhibiting at least one of the motions of the attachment (14) if the sensors (25, 26) do not detect the lock members (22, 23).

In the attachment fastening device of the invention with the receiving recess portions 4, 5 arranged with their openings facing each other, the attachment 14 is fixedly coupled to the fastening device 10 by inserting the mounting pins 12, 13 into the receiving recess portions 4, 5 such that the mounting pins 12, 13 are respectively pinched from the outside thereof. In the attachment fastening device with the receiving recess portions 4, 5 arranged with their backs facing each other, the attachment is fixedly coupled to the fastening device by inserting the mounting pins 12, 13 into the receiving recess portions 4, 5 such that the mounting pins 12, 13 are respectively pressed from the inside thereof. This fixing/coupling is done by the hydraulic device 11 placed between the members 2, 3.

According to the invention, if the operator recklessly forgets to attach the dropping-off preventing lock members 22, 23 after mounting the attachment 14 such as a bucket on the leading end of the arm 8 of the power shovel and starts up the power shovel, the motion indispensable for the operation of the power shovel is partially inhibited. This makes the operator immediately notice that the lock members have not been attached. Furthermore, the operation by use of the attachment cannot be started, unless a condition for perfect prevention of dropping-off of the attachment is established, so that the safety of the operation of the power shovel can be more increased.

Preferably, the inhibiting means 40 of the invention is for inhibiting the swaying motion of the attachment at the leading end of the arm. Specifically, it is preferable that the inhibiting means 40 inhibit the first motion of the attachment after the attachment is mounted. Generally, mounting of an attachment on a power shovel is done in the sate where the attachment is put on the ground and therefore it is desirable to inhibit the upward movement of the attachment such as the dumping motion of the attachment. Apart from the means for inhibiting the swaying motion of the attachment, there may be employed a structure for inhibiting the lifting motion of the arm or boom.

In the invention, the safety device preferably includes inhibition canceling means 44 for canceling the inhibition of the inhibiting means 40. During replacement of the attachment, the lock members 22, 23 are required to be dismounted. Since the inhibiting means 40 functions at that time, the manipulation of the attachment fastening device 10 mounted on the leading end of the arm is partially disabled, which may cause a trouble to the replacement of the attachment. In such a case, it is convenient to use the inhibition canceling means 44 such as an inhibition canceling switch for canceling the inhibition to recover the motion. The inhibition canceling switch may be of an automatically resetting type. This prevents a possible trouble caused by forgetting to reset the switch, so that more increased safety can be ensured.

### BRIEF DESCRIPTION OF DRAWINGS

FIG. 1 is a side view showing one example of attachment fastening devices equipped with the safety device of the invention.

FIG. 2 is a circuit diagram showing one example of hydraulic and electric control circuits.

FIG. 3 is a side view of an attachment fastening device equipped with a safety device of a conventional structure.

### DETAILED DESCRIPTION OF THE INVENTION

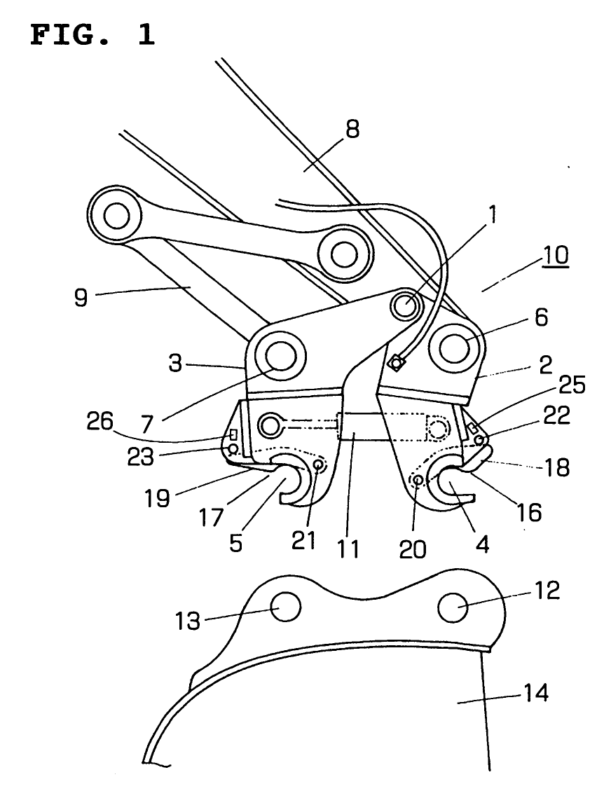

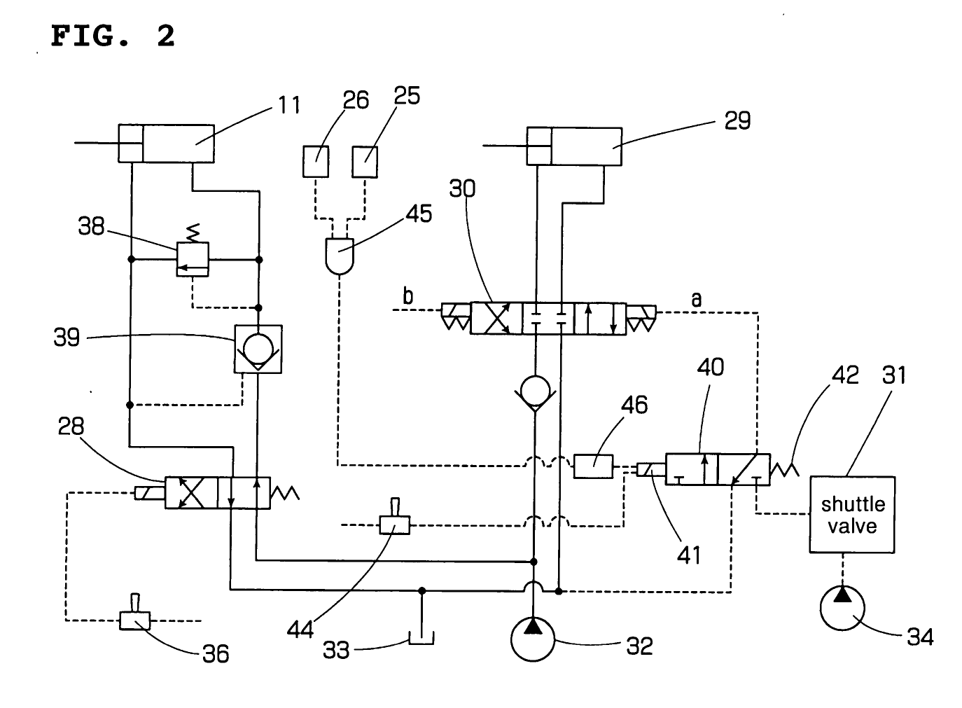

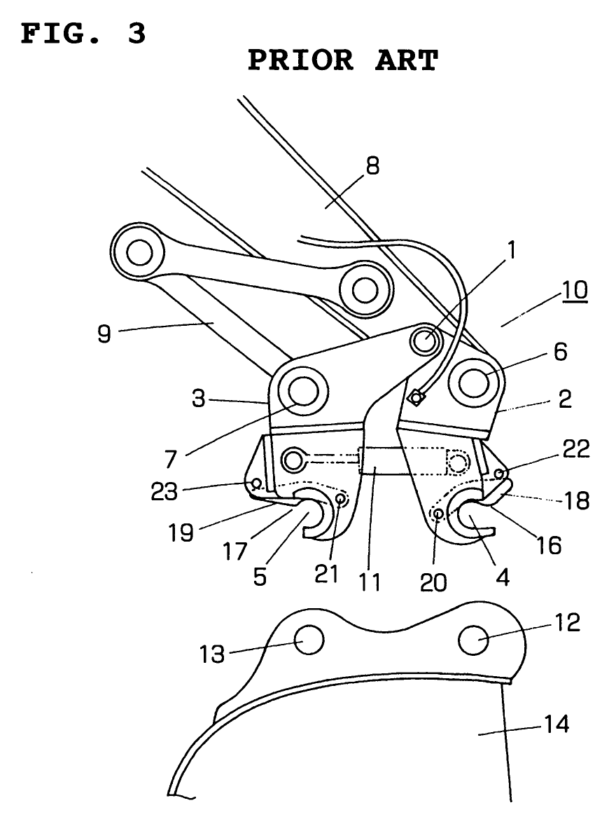

FIGS. 1, 2 are associated with an embodiment wherein the safety device of the invention is provided to an attachment fastening device having the structure shown in FIG. 3. In FIG. 1, the parts thereof corresponding to FIG. 3 are identified by the same reference numerals as in FIG. 3 and a detailed description thereof is omitted. It should be noted that reference numerals 25, 26 in FIG. 1 designate photoelectronic sensors that are secured to members 2, 3 respectively, for detecting mounting of lock pins 22, 23.

Mounting pins 12, 13 provided in an attachment 14 are inserted into receiving recess portions 4, 5 and engagement metal fittings 18, 19 are rotated such that their projections 16, 17 are allowed to project to the opening sides of the receiving recess portions 4, 5, and the retraction of the engagement metal fittings 18, 19 is prevented by the lock members 22, 23. Thereby, the openings of the receiving recess portions 4, 5 are narrowed so that dropping-off of the mounting pins 12, 13 is prevented.

FIG. 2 is a circuit diagram showing an essential part of a hydraulic circuit and its electric control circuit, the hydraulic circuit being designed to inhibit the dumping motion (i.e., where the attachment is a bucket, the operation of hoisting the bucket to dump earth and sand therefrom) of the attachment 14 if the lock pins 22, 23 are not detected by the photoelectronic sensors 25, 26. In FIG. 2, reference numeral 11 designates the fastening device opening/closing cylinder shown in FIG. 1; reference numeral 28 designates a selector valve for the cylinder 11; reference numeral 29 is an attachment swaying cylinder mounted in parallel with the arm of a power shovel; and reference numeral 30 is a pilot selector valve switched by pilot pressures a, b sent from a shuttle valve 31. Reference numeral 32 designates a main hydraulic pump; reference numeral 33 designates an oil tank; and reference numeral 34 designates a pump for the pilot hydraulic pressures. Although the actual hydraulic circuit of the power shovel includes at least an arm cylinder for lifting and lowering the arm; a boom cylinder for lifting and lowering the boom; and a pilot valve for switching these cylinders, they are omitted from FIG. 2.

When hydraulic power is supplied to the head end shown in FIG. 2, the fastening device opening/closing cylinder 11 expands to maintain a condition where the mounting pins 12, 13 of the attachment are fixedly held at the receiving recess portions 4, 5. Reference numeral 36 designates a switch for operating the selector valve 28 for the fastening device opening/closing cylinder 11. If the switch 36 is operated, the selector valve 28 is switched so that the fastening device opening/closing cylinder 11 is contracted/retracted and therefore the mounting pins 12, 13 of the attachment are released from the receiving recess portions 4, 5. If the switch 36 is operated by mistake while the lock pins 22, 23 are not attached, the fastening device opening/closing cylinder 11 is subjected to contractive retraction with the result that the attachment 14 drops from the leading end of the arm. It should be noted that reference numeral 38 designates a pressure adjustment valve for adjusting the fixing power exerted on the attachment 14 by the fastening device opening/closing cylinder 11 and reference numeral 39 designates a pilot check valve for preventing the contractive retraction of the fastening device opening/closing cylinder 11 due to external force etc.

When the pilot pressure a (on the right in FIG. 2) is imposed on the pilot selector valve 30 for operating the attachment swaying cylinder 29, the hydraulic pressure of the main pump 32 acts on the rod side of the attachment swaying cylinder 29 so that the attachment sways moving in an upward direction (dumping direction). On the other hand, when the pilot pressure b (on the left in FIG. 2) is imposed, the attachment sways moving in a downward direction (excavating direction). The pilot pressure a associated with the dumping direction is supplied from a shuttle valve 31 through an ON-OFF valve 40. The ON-OFF valve 40 is a normally-closed valve that is switched to a closed direction by a reset coil 42 when no electric power is applied to a solenoid 41. In this condition, the pilot selector valve 30 cannot be switched to the dumping direction by operating the shuttle valve 31.

Input to the solenoid 41 for the ON-OFF valve 40 are AND signals from the photoelectronic sensors 25, 26 shown in FIG. 1 and a signal from a canceling switch 44. Reference numeral 45 designates an AND circuit incorporated in the sensor circuit; and reference numeral 46 designates a relay. The canceling switch 44 is a normally open switch (switch that normally shuts off the cable run) of an autoregression type.

The solenoid 41 for the ON-OFF valve 40 is energized thereby transmitting the pilot pressure a of the shuttle valve 31 to the pilot selector valve 30, provided that the photoelectronic sensors 25, 26 both detect the lock pins 22, 23 or provided that the operator has operated the canceling switch 44. More specifically, if the lock pins 22, 23 are not mounted when replacement of the attachment is done, the pilot pressure is not transmitted to the pilot selector valve 30 even if the shuttle valve 31 is switched, so that the attachment mounted cannot be swayed in the dumping direction. Accordingly, the power shovel cannot be operated without attaching the mounting lock pins 22, 23 and thus a trouble caused by negligence in attaching the lock pins 22, 23 can be prevented.

On the other hand, when the attachment fastening device 10 needs to be operated in the dumping direction during replacement of the attachment, the canceling switch 44 is operated to enable the dumping motion. Thereby, a trouble caused by inhibition of the motion of the attachment fastening device 10 in the dumping direction during replacement of the attachment can be avoided.

What is claimed is:

1. A safety device for an attachment fastening device of a power shovel, which attachment fastening device comprises: a hydraulic device (11) for increasing and decreasing the spacing between a pair of members (2, 3) having, at the leading ends thereof, receiving recess portions (4, 5) which are arranged such that their openings face each other or their backs face each other; engagement metal fittings (18, 19) mounted in the neighborhood of the receiving recess portions (4, 5) respectively so as to be freely retractable and having projections (16, 17) that are projectable into the openings of the receiving recess portions (4, 5) respectively, while two mounting pins (12, 13) provided in an attachment (14) are being inserted into the pair of receiving recess portions (4, 5) and being kept in said inserted condition with the aid of the hydraulic power of the hydraulic device (11); and lock members (22, 23) for latching the engagement metal fittings (18, 19) while the projections (16, 17) projecting into the openings,
the safety device comprising:
sensors (25, 26) for detecting mounting of the lock members (22, 23); and
inhibiting means (40) for inhibiting at least one of the motions of the attachment (14) if the sensors (25, 26) do not detect the lock members (22, 23).

2. The safety device for an attachment fastening device of a power shovel according to claim 1,
wherein the inhibiting means (40) is for inhibiting the swaying motion of the attachment at the leading end of the arm.

3. The safety device for an attachment fastening device of a power shovel according to claim 1, further comprising:
inhibition canceling means (44) for canceling the inhibition of the inhibiting means.

4. The safety device for an attachment fastening device of a power shovel according to claim 2, further comprising:
inhibition canceling means (44) for canceling the inhibition of the inhibiting means.
